(19) United States
(12) Patent Application Publication
(10) Pub. No.: US 2010/0105486 A1
(43) Pub. Date: Apr. 29, 2010

(54) RFID-INCORPORATED GAME TOKEN AND MANUFACTURING METHOD THEREOF

(75) Inventor: Yasushi Shigeta, Osaka (JP)

Correspondence Address: LOWE HAUPTMAN HAM & BERNER, LLP, 1700 DIAGONAL ROAD, SUITE 300, ALEXANDRIA, VA, 22314, US

(73) Assignee: ANGEL PLAYING CARDS CO., LTD., Osaka (JP)

(21) Appl. No.: 12/593,653

(22) PCT Filed: Mar. 28, 2008
(86) PCT No.: PCT/JP2008/056184

§ 371 Date: Jan. 10, 2010

(30) Foreign Application Priority Data
Mar. 30, 2007 (JP) 2007-093929

(51) Int. Cl. A63F 9/24; B29C 45/14

(52) U.S. Cl. 463/47; 264/279.1

(57) ABSTRACT

A RFID tag incorporated game token that does not allow the RFID tag to be easily removed and hardly has failures in the RFID tag during manufacturing or in use is implemented. A game token (10) includes a body (11) produced by injection molding using thermosetting resin and an RFID tag (131) incorporated in the body (11) as a core (13). The RFID tag (131) is covered with cover sheets (132) and then preferably embedded in the body (11) by insert molding.

### TECHNICAL FIELD

The present invention relates to tokens for use in games and more particularly to an RFID-incorporated game token.

### BACKGROUND ART

In recent years, as the development of RFID tags has been advanced, the incorporation of an RFID tag in a token for a game has been suggested. For example, U.S. Pat. No. 6,659,875 discloses the arrangement in which an IC chip and an antenna are directly adhered to the backside of the front surface label of a token.

### DISCLOSURE OF THE INVENTION

### Problems to be Solved by the Invention

However, in the arrangement disclosed by U.S. Pat. No. 6,659,875, the IC chip can easily be removed or replaced by a different IC chip by peeling off the front surface label. Since the IC chip and the antenna are directly adhered to the backside of the front surface label, the IC chip can easily be damaged when the token is manufactured or used. In view of the problem, it is therefore an object of the present invention to provide a game token that does not allow an RFID tag to be easily removed and hardly has failures in the RFID tag during manufacturing or in use.

### Means for Solving the Problems

In order to achieve the above-described object, a game token according to the present invention includes a body and an RFID tag incorporated in the body, and the RFID tag is covered with sheets having flexibility or plasticity.

In this way, the RFID tag incorporated in the body cannot easily be removed and can resist externally applied stress. In addition, the RFID tag is covered with the sheets having flexibility or plasticity and therefore stress is absorbed by the sheets when the RFID tag is incorporated in the body, so that the RFID tag can be prevented from being damaged. Therefore, a game token that does not allow an RFID tag to be easily removed and hardly has failures in the RFID tag during manufacturing or in use can be provided.

In the game token according the present invention, paper is preferably used as the material of the sheet. Alternatively, vinyl chloride or polyethylene terephthalate is also preferably used.

In the game token according to the present invention, it is preferable that the body is formed to have a ring shape having a circumferential recess at its inner wall and the RFID tag covered with the sheets is fitted in the recess. Furthermore, seal resin may be provided on the RFID tag covered with the sheets.

Alternatively, in the game token according to the present invention, the body preferably has a rectangular shape.

Furthermore, in order to achieve the above-described object, a first method of manufacturing a game token according to the present invention manufactures a game token having an RFID tag incorporated in its body, and the RFID tag is covered with sheets having plasticity or flexibility. The method includes the steps of covering the RFID tag with sheets having flexibility or plasticity, providing the RFID tag covered with the sheets having flexibility or plasticity in a die, and forming a body having the RFID tag incorporated therein by injection molding.

According to the manufacturing method, since the RFID tag is incorporated in the body, a game token having the RFID tag that cannot easily be removed and can resist externally applied stress can be implemented. In addition, the RFID tag is covered with the sheets having flexibility or plasticity and therefore stress is absorbed by the sheets when the RFID tag is incorporated in the body, so that the RFID tag can be prevented from being damaged. Therefore, a game token that does not allow RFID to be easily removed and hardly has failures in the RFID tag during manufacturing or in use can be provided.

In order to achieve the above-described object, a second step of manufacturing a game token according to the present invention manufactures a game token having an RFID tag incorporated in its body, and the RFID tag is covered with sheets having plasticity or flexibility. The method includes the steps of forming a ring-shaped body having a circumferential recess at its inner wall by injection molding and fitting the RFID tag covered with the sheets having flexibility into the recess and injecting seal resin on the RFID tag.

According to the manufacturing method, the RFID tag is fitted in the inner circumference of the ring-shaped body and resin seals the upper surface, and therefore a game token that does not allow the RFID tag to be easily removed and can resist externally applied stress can be implemented. In addition, the RFID tag is covered with the sheets having flexibility, and therefore the RFID tag can be prevented from being damaged when the seal resin is injected. Therefore, a game token that does not allow an RFID tag to be easily removed and hardly has failures in the RFID tag during manufacturing or in use can be manufactured.

### EFFECTS OF THE INVENTION

As in the foregoing, according to the present invention, a game token that does not allow an RFID tag to be easily removed and hardly has failures in the RFID tag during manufacturing or in use can be provided.

### BRIEF DESCRIPTION OF THE DRAWINGS

FIG. 1A is a plan view of a chip according to a first embodiment of the present invention.

FIG. 1B is a sectional view taken along line A-A′ in FIG. 1A.

FIG. 2 is a partly cut away plan view of the structure of a core incorporated in the chip according to the first embodiment.

FIGS. 3A to 3C are schematic views showing essential steps in the process of manufacturing the core.

FIGS. 4A to 4C are schematic views showing another example of essential steps in the process of manufacturing the core.

FIG. 5 is a sectional view of a modification of the chip according to the first embodiment.

FIG. 6A is a perspective view of a chip according to another modification.

FIG. 6B is a sectional view taken along B-B′ in FIG. 6A.

FIG. 7A is a plan view of a chip according to a second embodiment of the present invention.

FIG. 7B is a sectional view taken along C-C′ in FIG. 7A.

### BEST MODE FOR CARRYING OUT THE INVENTION

Now, embodiments of the present invention will be described in detail in conjunction with the accompanying drawings.

### First Embodiment

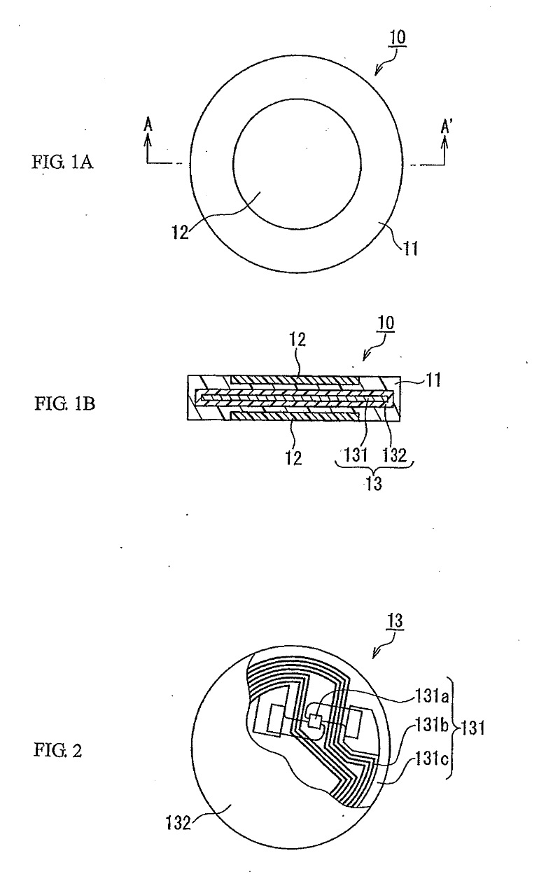

FIG. 1 shows the structure of a game token (hereinafter referred to as “chip”) 10 according to a first embodiment of the present invention. FIG. 1A is a plan view of the chip 10 and FIG. 1B is a sectional view of the chip 10 taken along A-A′ in FIG. 1A. Note that in FIGS. 1A, 1B and 2 and the other figures, elements of each chip are not drawn in actual size. For example, in FIG. 1B, the thickness of the elements inside the chip is emphasized for ease of illustration of the inside structure of the chip.

As shown in FIGS. 1A and 1B, the outer shape of the chip 10 according to the first embodiment is disk shaped. The chip 10 includes a body 11 that forms the outer shape of the chip, labels 12 laminated on both sizes of the body 11 and a core 13 embedded in the body 11. The core 13 includes an RFID tag 131 and cover sheets 132 that cover the entire RFID tag 131. The body 11 is normally formed by injection molding using thermosetting resin, colored in a color or provided with a number, a sign, a pattern or the like depending for example on the value of the chip 10. The body 11 has a recess on the main surface, and the label 12 is adhered to the recess. The label 12 is made of a resin film for example and used to print various kinds of information.

Now, with reference to FIG. 2, the structure of the core 13 will be described. As described in conjunction with FIG. 1, the core 13 includes the RFID tag 131 and the cover sheets 132 that cover the RFID tag 131. As shown in FIG. 2, the RFID tag 131 is formed by having an IC chip 131a and an antenna 131b provided on a single base film 131c or held between two base films 131c. Note that how to connect the IC chip 131a and the antenna 131b in the RFID tag 131 and the pattern shape or the like of the antenna 131b on the base film 131c are arbitrary and not limited to the arrangement shown in FIG. 2.

The IC chip 131a can be recorded with various kinds of information. Examples of such information include information indicating the value of the chip 10, information indicating the manufacturer of the chip 10, information indicating the owner of the chip 10, information indicating the date of manufacture of the chip 10, information indicating the date on which the chip 10 was obtained by the owner, information indicating the period in which the chip 10 can effectively be used and information indicating the place where the chip 10 can effectively be used. Needless to say, information that can be recorded on the IC chip 131a is not limited to the above-described examples.

The cover sheet 132 is a sheet used to cover the entire RFID tag 131 and paper, vinyl chloride, polyethylene terephthalate, or the like is suitably used for the material. The cover sheets 132 serve to protect the RFID tag 131 during injection molding of the body 11. The cover sheet 132, as will be described, needs only have such a degree of flexibility or plasticity that it conforms to the surface of the RFID tag 131 with the smallest possible gap and can adhere to the other cover sheet 132 around the RFID tag 131 when the sheets hold the RFID tag 131 therebetween. Note that the body 11 is preferably formed by so-called insert molding, according to which the core 13 is inserted in a die, and the core 13 is completely embedded inside the body 11 by injecting thermosetting resin around the core. Note that when the insert molding is employed, a support pin or the like used to support the core 13 in the die is necessary, and therefore a through hole in the shape of the support pin may remain in the body 11 after molding but such a through hole is not shown in the accompanying drawings.

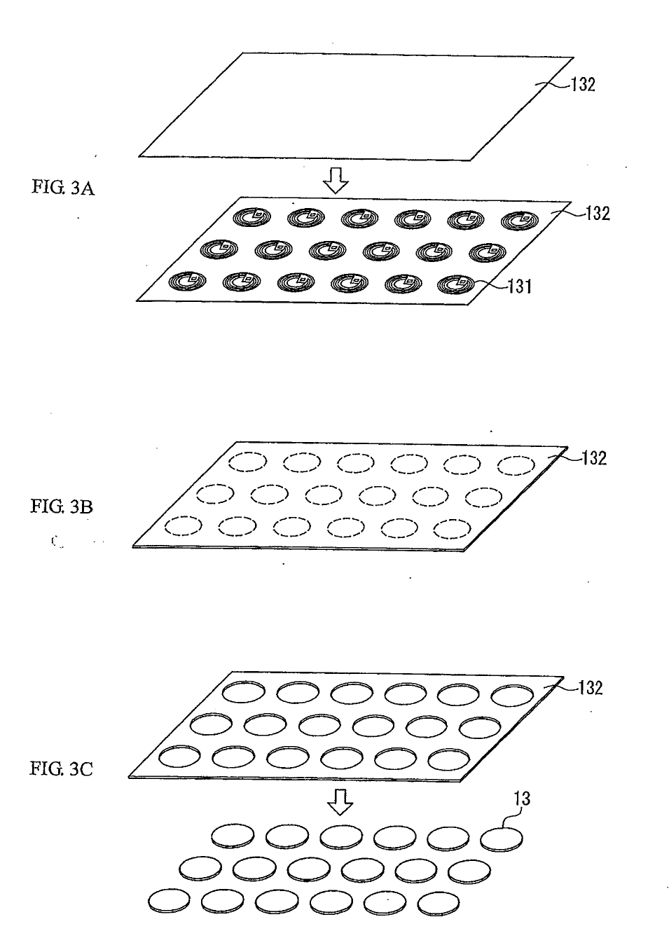

Now, with reference to FIG. 3, an example of a method of manufacturing the core 13 will be described. In this example, an adhesive (not shown) is applied on a cover sheet 132, a plurality of RFID tags 131 are arranged at prescribed intervals as shown in FIG. 3A. Then, another cover sheet 132 is placed thereon, and then the two cover sheets 132 are laminated to each other by the adhesive. In this way, as shown in FIG. 3B, the RFID tags 131 are held between the two cover sheets 132. Note that FIGS. 3A and 3B show examples only and the number of RFID tags 131 arranged on the cover sheet 132 is arbitrary. Note that the cover sheets 132 are laminated either while being heated at such temperatures that the RFID tag 131 is not destroyed depending on the property of an adhesive to use or without such heating.

Then, the cores 13 are cut from the cover sheets 132 as shown in FIG. 3C by punching processing so that each core has an outer diameter slightly larger than that of the RFID tag 131. Through the above-described steps, the cores 13 are produced.

In the example shown in FIG. 3, the RFID tag 131 is directly held between the two cover sheets 132, but a cushion member may be interposed between the RFID tag 131 and at least one of the two cover sheets 132. This is because the use of the cushion material can prevent problems such as disconnection of the antenna 131b and connection failures between the IC chip 131a and the antenna 131b when stress is applied for example in the following injection molding step. Alternatively, for the same purpose, the cover sheet 132 itself is preferably a cushiony material. In another example, the adhesive may be applied thickly, so that the adhesive serves as a cushion material.

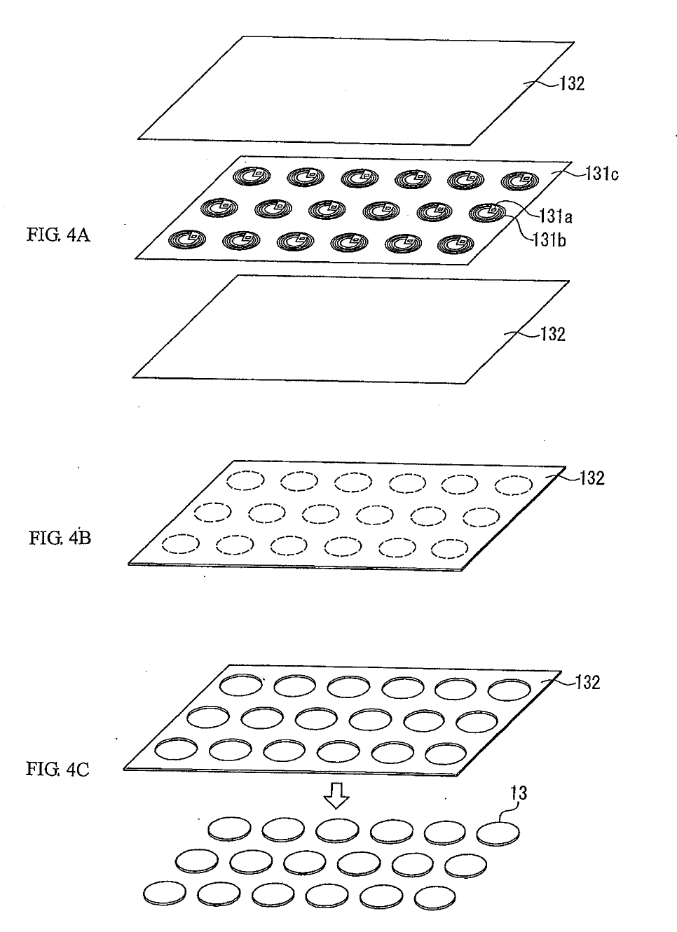

In the example shown in FIG. 3, the plurality of RFID tags 131 that have been separated in advance are arranged on the cover sheet 132, but the steps shown in FIG. 4 may be employed for the purpose of improving the production efficiency. More specifically, as shown in FIGS. 4A and 4B, a plurality of IC chips 131a and a plurality of antennas 131b may be formed at prescribed intervals on a single large base film 131c and the whole structure may be held between two cover sheets 132, followed by adhesion. Then, as shown in FIG. 4C, the cores 13 may be obtained by punching.

The core 13 formed in this way is provided in a die for insert molding, and thermosetting resin is injected around the core 13 and cooled, so that the body 11 having a sectional structure as shown in FIG. 1B is produced. Note that the method of injection-molding the body 11 is not limited to the insert molding. For example, after one surface on one side of the chip 10 is formed by a single injection molding step, a die is opened, the core 13 is provided therein, and another die for the surface on the other side is used to carry out a second injection molding step, so that the body 11 having the core 13 incorporated therein may be obtained. In some cases, when the body 11 is formed by insert molding, and the body 11 is provided with a pattern in multiple colors, using amounts of thermosetting resin colored in different colors from one another, injection molding is carried out multiple times for each of the colors while switching dies.

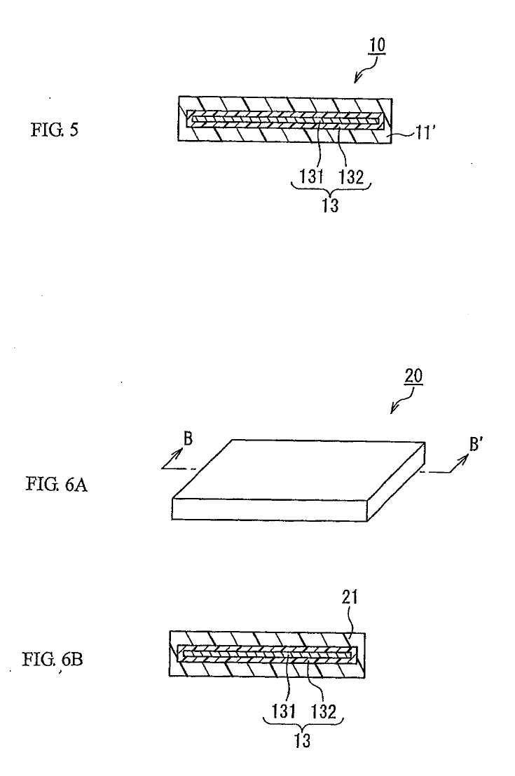

Finally, the labels 12 are adhered to both surfaces of the body 11, so that the chip 10 is completed. Note that according to the present embodiment, the arrangement having the labels 12 on both surfaces is shown by way of illustration, but only one surface of them may be provided with the label 12. The label 12 is not always necessary. More specifically, the surfaces of the body 11′ may be formed flat and free of any such labels as shown in FIG. 5.

As in the foregoing, in the chip 10 according to the present embodiment, the core 13 including the RFID tag 131 is embedded in the body 11. Therefore, if the labels 12 are removed, the RFID tag 131 cannot be removed from the chip 10. Furthermore, the RFID tag 131 is covered with the cover sheets 132, and therefore the RFID tag 131 can be prevented from being damaged when the core 13 is embedded in the body 11 by injection molding.

Note that in the above description, the outer shape of the chip 10 is disk-shaped by way of illustration, while not only the disk-shaped chip but also a so-called rectangular chip is also a modification of the first embodiment. Now, the structure of a rectangular chip as a modification of the first embodiment is shown in FIGS. 6A and 6B. The rectangular chip 20 shown in FIGS. 6A and 6B has a core 13 embedded in a rectangular body 21. The body 21 is formed by injection molding using thermosetting resin and is colored in a particular color or provided with a number, a sign, a pattern or the like depending for example on the value of the chip 20 or the like. The core 13 is embedded in the body 21 by insert molding. Note that a label, a surface protection sheet and the like may further be laminated on the surface of the body 21.

In the chip 20 having this structure, the RFID tag 131 cannot be removed. The RFID tag 131 is covered with the cover sheets 132 and therefore the RFID tag 131 can be prevented from being damaged when the core 13 is embedded in the body 21 by injection molding.

### Second Embodiment

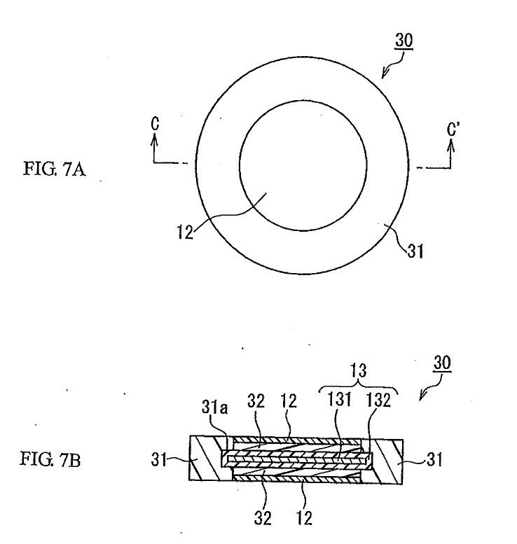

FIG. 7 includes views showing the structure of a chip 30 according to a second embodiment of the present invention, FIG. 7A is a plan view of the chip 30, FIG. 7B is a sectional view of the chip 30 taken along C-C′ in FIG. 7A, and FIG. 7C is a sectional view showing the state of the body 31 in the chip 30. Note that components described in connection with the first embodiment will be designated by the same reference characters as those in the first embodiment and their detailed description will not be repeated.

As shown in FIGS. 7A and 7B, the outer shape of the chip 30 according to the second embodiment is disk-shaped. The chip 30 has a ring-shaped body 31, a core 13 fitted in the body 31, seal resin 32 inserted on the core 13 and labels 12 adhered to both surfaces of the chip 30. Similarly to the first embodiment, the core 13 includes an RFID tag 131 and cover sheets 132 that cover the entire RFID tag 131. The body 31 is formed by injection molding using thermosetting resin and normally colored in a particular color or provided with a number, a sign, a pattern or the like depending on the value of the chip 30.

A circumferential recess 31a is formed at the inner wall of the body 31. The core 13 is fitted in the recess 31a and supported. More specifically, the RFID tag 131 is in the ring shaped body 31 while it is incorporated in the core 13. The seal resin 32 is made of a material such as thermosetting resin so that it cannot be peeled off easily by fingers or a pen. The seal resin also serves to protect the core 13 against externally applied pressure or the like. Note that the seal resin 32 may also be used as an adhesive to adhere the labels 12.

The chip 30 is produced as follows. To start with, a body 31 is formed by injection molding. Then, a core 13 is formed in the manner described with reference to FIGS. 3A to 3C in connection with the first embodiment. The core 13 is then fitted to the recess 31a of the body 31. Note that the cover sheets 132 according to the present embodiment are sometimes bent as the core 13 is fitted to the recess 31a of the body 31, and therefore the sheets are made of a flexible material. Since the RFID tag 131 and the cover sheets 132 are both flexible, the core 13 can readily be fitted to the recess 31a of the body 31 by bending its peripheral part. Then, thermosetting resin 32 is injected on the core 13 in the ring of the body 31, and the labels 12 are adhered thereon, so that the chip 30 is completed. Note that the seal resin 32 is not always necessary, and the space therefor may remain as a gap, or a protection member such as paper may be provided therein.

As in the foregoing, in the chip 30 according to the present embodiment, the core 13 including the RFID tag 131 is fitted in the body 31. More specifically, the RFID tag 131 is included in the ring shaped body 31 as it is incorporated in the core 13. The seal resin 32 that cannot be peeled off easily by fingers, a pen or the like is inserted under the labels 12. Therefore, if the labels 12 are peeled off, the RFID tag 131 cannot easily be removed from the chip 30. The RFID tag 131 is covered with the flexible cover sheets 132 and thus protected against damages. The RFID tag 131 is covered with the flexible cover sheets 132 and therefore the core 13 can easily be fitted into the recess 31a at the inner wall of the body 31. In addition, the cover sheets 132 also protect the RFID tag 131 against damages when the seal resin 32 is injected.

Note that also in the chip 30, the label 12 is not always necessary, and the surface of the body 31 may be formed flush with the surface of the seal resin 32.

### INDUSTRIAL APPLICABILITY

The present invention has industrial applicability in the field of game tokens.

1. A game token comprising:
a body; and
an RFID tag incorporated in the body,
the RFID tag being covered with sheets having flexibility or plasticity.

2. The game token according to claim 1, wherein the sheet is a paper sheet.

3. The game token according to claim 1, wherein the sheet is a vinyl chloride or polyethylene terephthalate sheet.

4. The game token according to claim 1, wherein the body is formed to have a ring shape having a circumferential recess at its inner wall, and
the RFID tag covered with the sheets is held in the recess.

5. The game token according to claim 4, wherein seal resin is provided on the RFID tag covered with the sheets.

6. The game token according to claim 1, wherein the body has a rectangular shape.

7. A method of manufacturing a game token having an RFID tag incorporated in its body, the RFID tag being covered with sheets having plasticity or flexibility, comprising the steps of:
providing an RFID tag covered with sheets having flexibility or plasticity in a die; and
forming a body having the RFID tag incorporated therein by injection molding.

8. A method of manufacturing a game token having an RFID tag incorporated in its body, the RFID tag being covered with sheets having flexibility, comprising the steps of:
forming a ring-shaped body having a circumferential recess at its inner wall by injection molding;
fitting the RFID tag covered with the sheets having flexibility into the recess; and
injecting seal resin on the RFID tag.
